(19) United States
(12) Patent Application Publication
(10) Pub. No.: US 2005/0160177 A1
(43) Pub. Date: Jul. 21, 2005

(54) Storage medium storing multimedia data, and method and apparatus for reproducing multimedia data

(75) Inventor: Hae-Kwang Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/029,568

(22) Filed: Jan. 6, 2005

(30) Foreign Application Priority Data
Jan. 17, 2004 (KR) 2004-3571

(51) Int. Cl. G06F 15/16

(52) U.S. Cl. 709/231; 709/219

(57) ABSTRACT

A storage medium storing multimedia data, and method and apparatus for reproducing multimedia data are provided. The storage medium includes at least one media stream; and additional information, wherein the media stream is divided into streaming data streamed over a network and download data downloaded over the network, and the additional information indicates how to combine the streaming data and the download data.

### CROSS-REFERENCE TO RELATED APPLICATION

This application claims the benefit of Korean Patent Application No. 2004-3571, filed on Jan. 17, 2004, in the Korean Intellectual Property Office, the disclosure of which is incorporated herein in its entirety by reference.

### BACKGROUND OF THE INVENTION

1. Field of the Invention

The present invention relates to encoding of multimedia contents, and more particularly, to a storage medium storing multimedia data structured for streaming, and a method and apparatus for reproducing the multimedia data.

2. Description of the Related Art

Multimedia data, such as video data, audio data, computer animation data, or any combination thereof, is synchronously reproduced according to a time sync of each data, or time syncs between data. For example, time sync information is included in each of audio data and video data in order for them to be reproduced together in synchronization, and information is included in each of them indicating when they should be output. By streaming such multimedia data over a wired/wireless network, e.g., the Internet, educational, entertainment, or other contents can be provided to a user.

Streaming services are limited by certain network conditions, such as network jitter, channel bandwidth, transmission delay, packet loss ratio, bit error ratio, etc., and terminal settings, such as data throughput, memory capacity, etc.

Korean Patent Publication No. 2002-95001 discloses a streaming service technology combining conventional download and streaming technologies, in which a multimedia stream file is divided into a download file and a streaming file, and when a user requests a desired stream through a terminal, the terminal checks whether there is a corresponding download file within itself, and if there is no such download file, streaming and download files that correspond to the desired stream are transferred together from a server to the terminal. On the other hand, if there is a corresponding download file in the terminal, only a streaming file is transferred to the terminal from the server. This streaming service technology simply combining the conventional download and streaming technologies only works when both the terminal and the server recognize a predetermined structure of combining the streaming file and the download file in advance, and cannot provide various other structures of combining various streaming and download files. Also, the streaming service technology may not work when no corresponding download file is found in the terminal, and so the terminal should download the file from the server, which takes up considerable storage space in the terminal.

### SUMMARY OF THE INVENTION

The present invention provides a storage medium storing multimedia data, and a method and apparatus for reproducing multimedia data, in which a multimedia contents service combining various streaming download technologies can be provided by utilizing additional information on the contents.

Additional aspects and/or advantages of the invention will be set forth in part in the description which follows and, in part, will be obvious from the description, or may be learned by practice of the invention.

According to an aspect of the present invention, there is provided a storage medium storing multimedia data, said multimedia data including: at least one media stream; and additional information, wherein the media stream includes streaming data streamed over a network and download data downloaded over the network, and the additional information indicates how to combine the streaming data and the download data.

According to an aspect of the present invention, the additional information regarding data transferred over the network includes information about a name of a file having the data, a location, a data size, and/or meta-information.

According to an aspect of the present invention, the media stream includes contents additional information used to combine a first sub stream including the streaming data and a second sub stream including the download sub stream so as to recover the media stream.

According to an aspect of the present invention, the contents additional information includes: information about the number of media streams making up multimedia data; and stream additional information regarding attributes of the media streams.

According to an aspect of the present invention, the stream additional information includes: information about identifiers of the first sub stream and the second sub stream; information about whether the first sub stream or the second sub stream is download data or streaming data; and information about a structure of the download data and the streaming data.

According to another aspect of the present invention, there is provided a method of reproducing multimedia data in a terminal, the method including: receiving contents additional information regarding a data structure of at least one of media streams making up multimedia data over a network; requesting download data over the network according to the contents additional information, and receiving and storing resulting download data; requesting streaming data over the network according to the contents additional information, and receiving and storing resulting streaming data; and using the download and streaming data stored in the terminal to recover and reproduce an original media stream, according to the contents additional information.

According to an aspect of the present invention, the contents additional information includes: information about the number of the media streams making up the multimedia data; and stream additional information regarding attributes of the media streams.

According to an aspect of the present invention, the stream additional information includes: information about identifiers of first and second sub streams making up a media stream; information about whether the first sub stream or the second sub stream is download data or streaming data; and information about a structure of the download data and the streaming data.

According to still another aspect of the present invention, there is provided an apparatus for reproducing multimedia data, the apparatus including: a download sub stream buffer that receives download sub streams from a streaming server over a network; a streaming sub stream buffer that receives streaming sub streams from the streaming server over the network; a decoder that combines the download sub streams and the streaming sub streams to make a media stream and decode the media stream; and a renderer that reproduces decoded media streams according to time syncs between the decoded media streams.

According to an aspect of the present invention, the apparatus further includes a download sub stream storage unit that stores a plurality of download sub streams including of download data received from the streaming server.

According to an aspect of the present invention, the apparatus further includes a de-multiplexer that generates a plurality of streaming sub streams from streaming data received from the streaming server.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a multimedia data structure according to the present invention;

FIG. 2 shows media streams including of download segments and streaming segments;

FIG. 3 shows download sub streams and streaming sub steams collected from the media streams of FIG. 2;

FIG. 4 shows the contents of additional information of FIG. 3;

FIG. 5 is a block diagram illustrating a streaming service provided from a server to a reproducing apparatus, according to an embodiment of the present invention;

FIG. 6 is a block diagram of a reproducing apparatus, according to an embodiment of the present invention; and

FIG. 7 is an embodiment of additional information compatible with an MPEG-4 standard.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

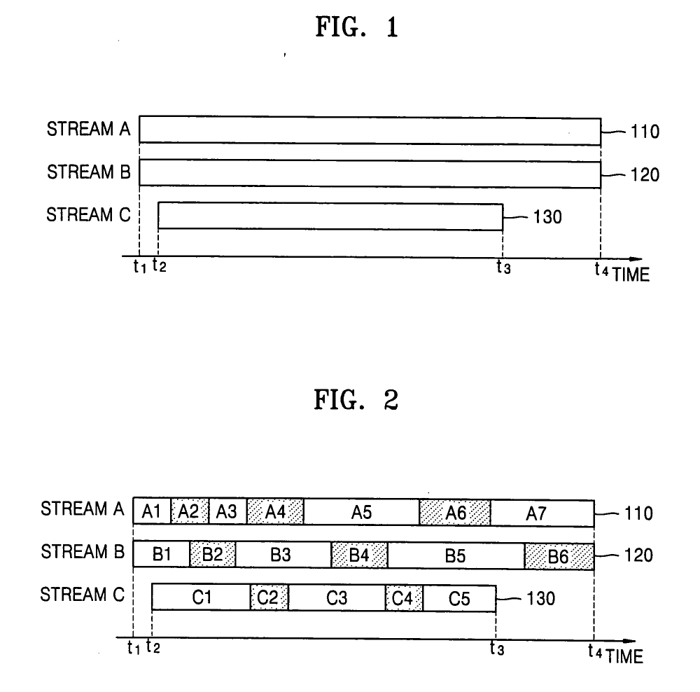

FIG. 1 shows a multimedia data structure according to the present invention.

Multimedia contents may include various data, e.g., video, audio, texts, etc., each of which can be referred to as a media stream. Referring to FIG. 1, an example of multimedia contents including 3 media streams: media steam A 110, media stream B 120, and media stream C 130, each of which contains intra-media time sync information achieving internal synchronization and inter-media time sync information for synchronizing with other media streams. The intra-media time sync information and the inter-media time synch information can be generated by using a system reference clock.

The time synch information will now be described in detail. In the case of an MPEG-4 system, a starting time of reproducing each media stream is recorded at ‘startTime’ of node information in binary format or scene description (BIFS). Information on a location of each media stream is also recorded in the BIFS. A media stream is divided into access units, which are basic units of decoding and are carried in a synchronization layer packet (SL Packet). Information about composition time stamp (CTS), decoder time stamp (DTS), and object clock reference (OCR) are recorded in a header of the SL Packet. By using the information about CTS, DTS, and OCR, time synchronization within a media stream and between media streams can be achieved.

FIG. 2 shows media streams including download segments and streaming segments.

Referring to FIG. 2, each of media streams 110,120, and 130 includes download segments (shaded portions) and streaming segments. The download segments are downloaded from a server to a terminal over a network before the server starts streaming, and the streaming segments are transferred to the terminal in real time by the server's streaming. The size of the streaming segment and the size of the download segment are determined according to a data transfer ratio of the network and input buffer capacity of the terminal. For example, in order to avoid an input buffer overflow or underflow, a part of the input buffer can be first assigned to the streaming segments, and the remaining parts of the input buffer assigned to the download segments. In the case of an MPEG-4 system, the download segments and the streaming segments include a plurality of access units.

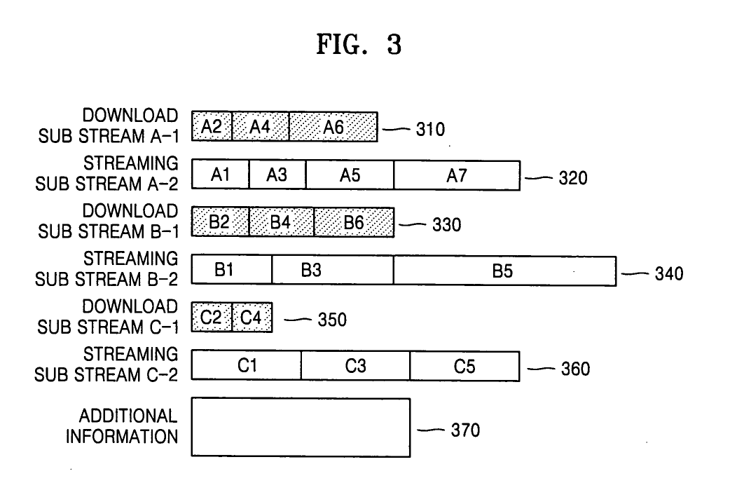

FIG. 3 shows download sub streams and streaming sub steams collected from the media streams of FIG. 2.

Referring to FIG. 3, stream A of FIG. 2 can be divided into a download sub stream A-1 310 and a streaming sub stream A-2 320, for example. The download sub stream A-1 310 may include download segments A2, A4, and A6, and the streaming sub stream A-2 320 may include streaming segments A1, A3, AS, and A7.

Similarly, stream B of FIG. 2 includes a download sub stream B-1 330 and a streaming sub stream B-2 340, for example. The download sub stream B-1 330 may include B2, B4, and B6, and the streaming sub stream B-2 340 may include B1, B3, and B5.

Further, stream C of FIG. 2 can be divided into a download sub stream C-1 350 and a streaming sub stream C-2 360, for example. The download sub stream C-1 350 may include of C2, and C4, and the streaming sub stream C-2 360 may include of C1, C3, and C5.

Additional information 370 is needed to recover original media streams using the download sub streams and the streaming sub streams.

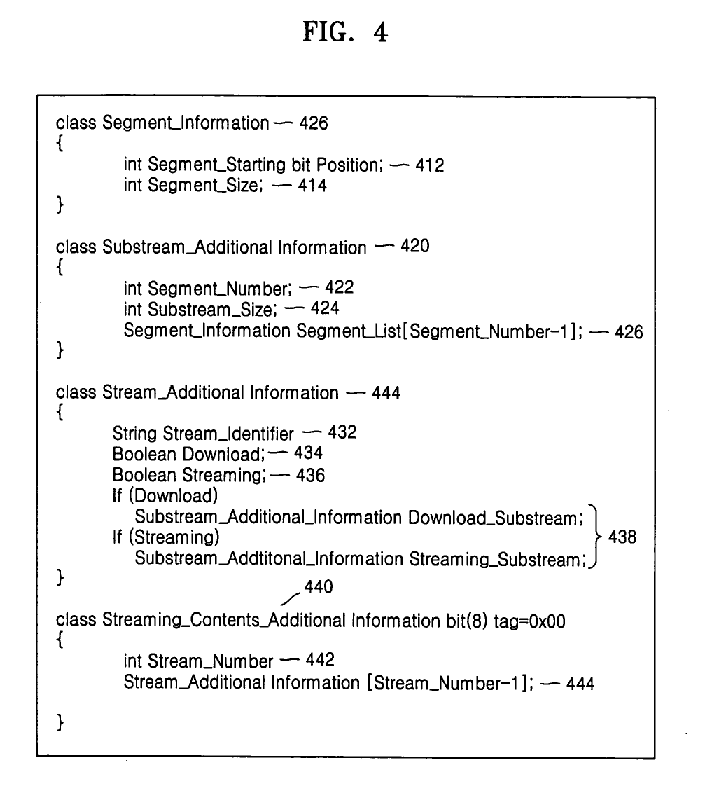

FIG. 4 shows the contents of the additional information 370 of FIG. 3.

Here, it is noted that technology used to represent copyright information, metadata information, keyword information, etc., which is practiced in a conventional contents encoding method, can also be included in the additional information shown in FIG. 4. Accordingly, the additional information will now be described in terms of providing streaming service according to an embodiment of the present invention.

Referring to FIG. 4, “streaming_contents_additional information” 440 is information regarding multimedia contents provided by the streaming service, and can include the number of streams “stream_number” 442 making up the multimedia contents, and additional information “stream_additional information” 444 of each stream.

The “stream_additional information” 444 includes information on an identifier “stream_identifier” 432 for identifying a corresponding stream, and information about download sub streams 434 and streaming sub streams 436. A stream, as a whole, can be made up of download sub streams or streaming sub streams, and further includes stream additional information regarding download sub streams or streaming sub streams according to a Boolean value of the information about the download sub stream 434 or the streaming sub stream 436, each of which is in Boolean data format.

The stream additional information regarding download sub streams or streaming sub streams is recorded as “substream_additional information” 420. The “substream_additional information” 420 may include the number of segments, “segment_count” 422 making up the sub streams, the size of sub steams “substream_size” 424, and a list of segments, “segment-list” 426. The “segment_list” 426 may include starting position of the segments in bytes, “segment_start” 412, and the size of segments, “segment_size” 414.

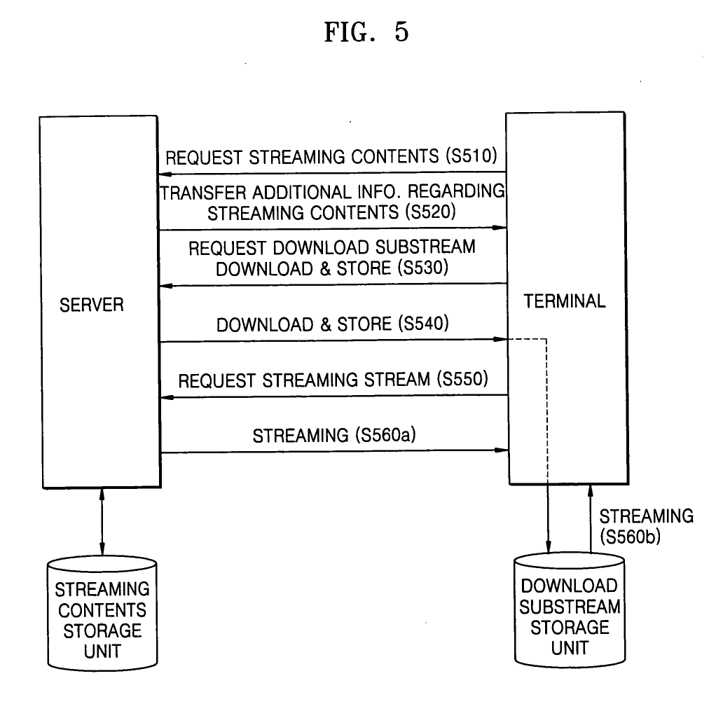

FIG. 5 is a block diagram illustrating a streaming service provided from a server to a reproducing apparatus, according to an embodiment of the present invention.

Here, conventional protocols used in authentication, session management, etc., of streaming service can also be used, however, the streaming service shown in FIG. 5 will be described according to an additional protocol of an aspect of the present invention.

First, a terminal requests streaming contents from a server, in operation S510. The server transfers additional information regarding the requested streaming contents, as shown in FIG. 4, to the terminal, in operation S520. The terminal determines whether it has sufficient storage capacity to download the streaming contents according to the additional information, and if so, it requests the server to download sub streams of the streaming contents, in operation S530. In operation S540, the server transfers the download sub streams to the terminal and the terminal stores the download sub streams in a download sub stream storage unit. After completing downloading of the download sub streams, the terminal requests streaming service from the server, in operation S550. The terminal combines the download sub streams stored in the data storage unit and the real time streaming sub streams provided by the streaming service of the server, in operation S560a, to generate and reproduce original streaming contents according to the additional information, in operation S560b.

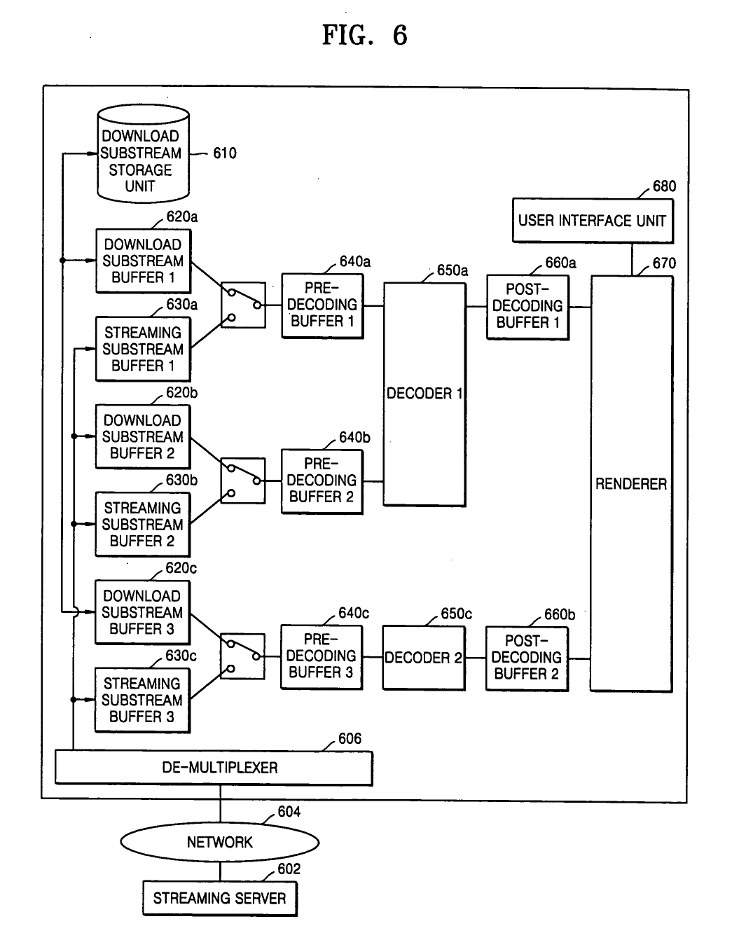

FIG. 6 is a block diagram of a reproducing apparatus (terminal), according to an embodiment of the present invention.

Referring to FIG. 6, download sub streams can be previously transferred from the server and stored in a download sub stream storage unit 610. Real-time streaming sub streams transferred from the server 602 over a network 604 are split up into several streams, e.g., 3 streams, by a de-multiplexer 606, and each of the streams is stored in a sub stream buffer 1 630a, sub stream buffer 2 630b, or sub stream buffer 3 630a according to information about a decoding time symbol, e.g., DTS in a MPEG-4 system, and a stream identifier, before decoding starts. Download sub stream buffer 1 620a, download substream buffer 2 620b, and download substream buffer 3 620c store streams divided from download sub streams stored in the download sub stream storage unit 610. Pre-decoding buffer 1 640a, predecoding buffer 2 640b, and predecoding buffer 3 640c are separately arranged according to the type of streams. For a media stream, a pre-decoding buffer 1 640a sequentially reads and outputs the download and streaming sub streams by accessing the download sub stream buffer 1 620a and the streaming sub stream buffer 1 630a, according to the information about the decoding time stamp of the download and streaming sub streams.

Thus, media stream decoders 650a and 650b, and a renderer 670, can operate the same way as in a conventional method/apparatus. In FIG. 6, there are 2 pre-decoding buffers 640a and 640b needed for a media stream, which are examples for a base layer stream and an elementary layer stream according to a scalable coding compression method.

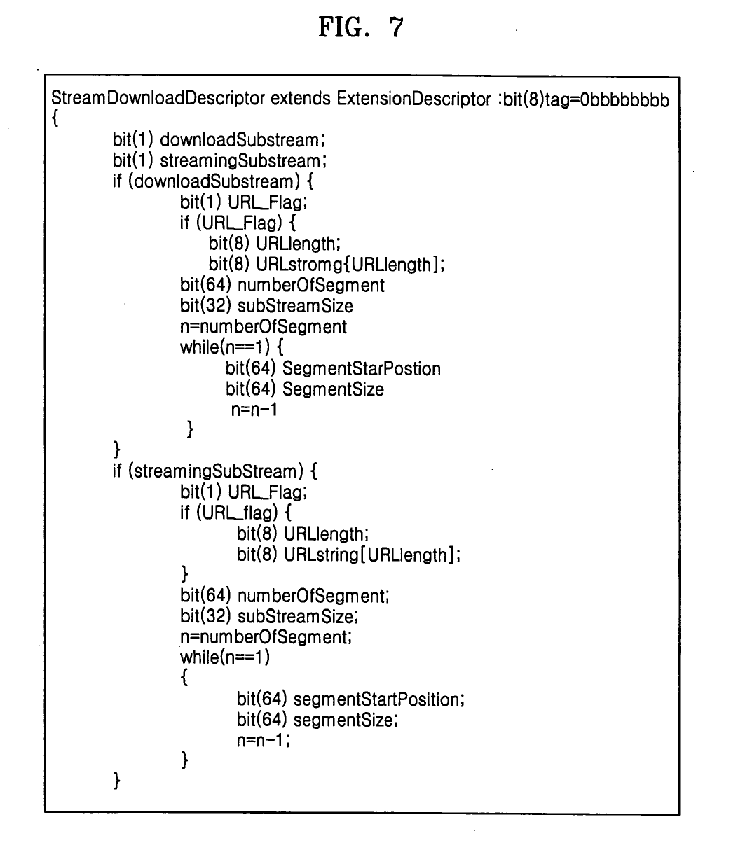

FIG. 7 illustrates additional information that is compatible with the MPEG-4, standard according to another embodiment of the present invention.

According to the MPEG-4 standard, information on a structure of contents is represented by BIFS and an object descriptor (OD), which together are referred to as an initial object descriptor (IOD). The embodiment of FIG. 7 uses an extension descriptor included in an elementary stream descriptor for describing an MPEG-4 media stream, in order for additional information such as that shown in FIG. 4 to be compatible with conventional MPEG-4. Referring to FIG. 7, “downloadSubstream” and “streamingSubstream” are information indicating whether a present media stream includes download sub streams or the streaming sub streams, and each includes the number of segments “numberOfSegment” divided from the download sub steams or the streaming sub streams, the size of corresponding sub streams in bytes “subStreamSize”, a starting position “SegmentStartPosition” in bytes of segments constituting the corresponding sub stream(s), “SegmentStartPosition”, and the size of a segment “SegmentSize”. “URL_flag”, “URLlength”, and “URLstring” are used to indicate a URL location of the corresponding sub stream(s), according to which a terminal can download the download sub stream and request streaming of the streaming sub stream from the URL location.

If the compatibility with conventional MPEG-4 streams is not required, the additional information regarding a media stream may include a new descriptor that represents information as shown in FIG. 7, as well as the descriptor used for the MPEG-4 system.

The required storage capacity of the download stream storage unit of the terminal can be estimated in advance by summing the length of all of the download streams. Alternatively, the required storage capacity of the download stream storage unit can be determined from information included in the additional information regarding the media contents. In the case of the MPEG-4 system, information about the required storage capacity of the download stream storage unit is recorded at IOD. The terminal compares the storage capacity of the download stream storage unit according to the information with an actual available storage space of the download stream storage unit, and determines from the result of the comparison whether to request download streams from the server.

It is possible for the method of reproducing multimedia data described above, according to embodiments of the present invention, to also be implemented by computer readable code. Codes and code segments making up the computer readable code may readily be inferred by those skilled in the art. The computer readable codes may be transferred by computer readable media, and be read and executed by computers. Such computer readable media includes all kinds of storage devices, such as magnetic storage devices, optical data storage devices, etc. The computer readable media also include everything that is realized in the form of carrier waves, e.g., an Internet transmission.

Although a few embodiments of the present invention have been shown and described, it would be appreciated by those skilled in the art that changes may be made in these embodiments without departing from the principles and spirit of the invention, the scope of which is defined in the claims and their equivalents.

1. A medium comprising multimedia data, said multimedia data comprising:
at least one media stream; and
additional information,
wherein the media stream is divided into streaming data streamed over a network and download data downloaded over the network, and the additional information indicates how to combine the streaming data and the download data.

2. The storage medium of claim 1, wherein the additional information regarding data transferred over the network further comprises information about a name of a file having the multimedia data, a location, a data size, and/or meta-information.

3. The storage medium of claim 1, wherein the media stream comprises contents additional information used to combine a first sub stream comprised of the streaming data and a second sub stream comprised of the download sub stream so as to recover the media stream.

4. The storage medium of claim 3, wherein the contents additional information comprises:
information about a number of media streams making up the multimedia data; and
stream additional information regarding attributes of the number of media streams.

5. The storage medium of claim 4, wherein the stream additional information comprises:
information about identifiers of the first sub stream and the second sub stream;
information about whether the first sub stream or the second sub stream is download data or streaming data; and
information about a structure of the download data and the streaming data.

6. A method of reproducing multimedia data, the method comprising:
receiving contents additional information regarding a data structure of at least one media stream making up multimedia data;
requesting a download data, and receiving and storing the download data; and
requesting a streaming data, and receiving and storing the streaming data.

7. The method of claim 6, wherein the contents additional information comprises:
information about a number of the media streams making up the multimedia data; and
stream additional information regarding attributes of the number of media streams.

8. The method of claim 7, wherein the stream additional information comprises:
information about identifiers of first and second sub streams making up the media stream;
information about whether the first sub stream or the second sub stream is download data or streaming data; and
information about a structure of the download data and the streaming data.

9. The method of claim 6, further comprises using the stored download and streaming data to recover and reproduce an original media stream, according to the contents of additional information.

10. An apparatus for reproducing multimedia data, the apparatus comprising:
a download sub stream buffer that receives download sub streams from a streaming server;
a streaming sub stream buffer that receives streaming sub streams from the streaming server; and
a decoder that combines the download sub streams and the streaming sub streams to make a media stream and decode the media stream,

11. The apparatus of claim 10, further comprising a download sub stream storage unit that stores a plurality of download sub streams comprised of download data received from the streaming server.

12. The apparatus of claim 10, further comprising a de-multiplexer that generates a plurality of streaming sub streams from streaming data received from the streaming server.

13. The apparatus for reproducing the multimedia data of claim 10, further comprises a renderer that reproduces decoded media streams according to time syncs between the decoded media streams.

14. The apparatus for reproducing the multimedia data of claim 10, wherein the download substreams are transferred by a network.

15. A method of receiving a multimedia data, the method comprising:
receiving a contents additional information regarding a data structure of at least one media stream making up the multimedia data;
checking whether a storage capacity is sufficient to store the multimedia data;
requesting a download data if the storage capacity is sufficient to store the download data and receiving and storing the download data.

16. The method of receiving the multimedia data of claim 15, wherein the method further comprises receiving and storing a streaming data.

17. The method of receiving the multimedia data of claim 16, the method further comprises requesting the stream data.

18. The method of receiving the multimedia data of claim 16, the method further comprises reproducing an original multimedia data from the stored download data and the streaming data.

19. A computer-readable medium having embedded thereon computer readable code controlling the implementation of the method of claim 6.

20. A computer-readable medium having embedded thereon computer readable code controlling the implementation of the method of claim 12.
